(19) United States
(12) Patent Application Publication
(10) Pub. No.: US 2012/0131553 A1
(43) Pub. Date: May 24, 2012

(54) SOURCE CODE FILE MANAGEMENT SYSTEM AND METHOD

(75) Inventor: TENG-YU TSAI, Tu-Cheng (TW)

(73) Assignee: HON HAI PRECISION INDUSTRY CO., LTD., Tu-Cheng (TW)

(21) Appl. No.: 13/195,928

(22) Filed: Aug. 2, 2011

(30) Foreign Application Priority Data
Nov. 23, 2010 (TW) 99140463

(51) Int. Cl. G06F 9/44

(52) U.S. Cl. 717/122; 717/120

(57) ABSTRACT

A source code file management system includes a first receiving module, a generating module, a retrieving module, a determining module, a transmitting module, a second receiving module, a storing module and a message module. The first receiving module receives a source code file from a developer client associated with a developer. The generating module generates an intermediate file based on the source code file. The retrieving module retrieves a developer profile associated with the developer. The determining module determines examiners according to the developer profile. The transmitting module transmits the intermediate file to examiner clients associated with the examiners. The second receiving module receives examining results from the examiner clients. The storing module stores the source code file in a source code storage when each examining result is accepted.

### BACKGROUND

1. Technical Field

The disclosure generally relates to a source code file management system and a source code file management method.

2. Description of Related Art

Source code is a sequence of statements that is usually written in a high level programming language, such as, without limitation, C programming language, C++, or Java™. Source code is usually stored in one or more text files until the code is compiled and executed. As a program is designed and developed, frequently multiple versions of the same program are often deployed at different sites for utilization by multiple program developers. In such a case, a source code file is often edited by members of a team. The team members may be in different physical locations and they may apply updates to the source code without team consultation. In such situations, version control systems are frequently used to track and account for ownership of updates and changes to files and code. However these version control systems do not investigate the source code file before the source code file is committed to a source code repository. Therefore there is room for improvement in source code file management.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic diagram of one embodiment of a computing device including a source code file management system.

FIG. 2 is a schematic diagram of one embodiment of the function modules of the source code file management system of FIG. 1.

FIG. 3 is an examiner sequence generated by the source code file management system according an embodiment.

FIG. 4 is an operational flow diagram representing an exemplary embodiment of a method for examining a source code file before the source code file is committed.

FIG. 5 is an operational flow diagram representing an exemplary embodiment of a method for generating an intermediate file based on a source code file.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

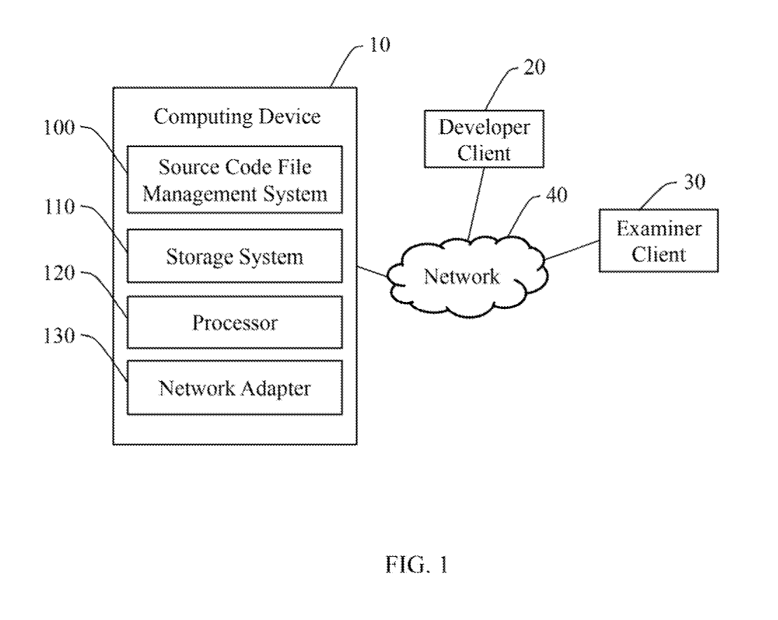

FIG. 1 is a schematic diagram of one embodiment of a computing device 10. In the embodiment, the computing device 10 may include a source code file management system 100, a storage system 110, at least one processor 120, and a network adapter 130. The computing device 10 implements the functions of the source code file management system 100. The source code file management system 100 is accessible to at least one developer client 20 and at least one examiner client 30 via a network 40. The computing device 10 may be a desktop computer, a workstation, or a laptop computer.

In one embodiment, the storage system 110 may be a magnetic or an optical storage system, such as a hard disk drive, an optical drive, or a tape drive. The storage system 110 may allocate space for a source code storage (not shown). The source code storage is a repository where current and historical files associated with source code is stored. A source code file stored in the source code storage may be associated with a unique version number that identifies the source code file.

The network adapter 130 may be a network interface card using a specific physical layer and a data link layer standard such as Ethernet or Wi-Fi. The network 40 may be a local area network (LAN), or a wide area network (WAN), such as the Internet.

The developer client 20 represents a developer in a multi-developer project. The developer can utilize the developer client 20 to submit a commit request and a source code file to the source code file management system 100. The examiner client 30 represents an examiner who is responsible for examining the source code file submitted by a developer. The source code file management system 100 may communicate with multiple developer clients 20 and multiple examiner clients 30.

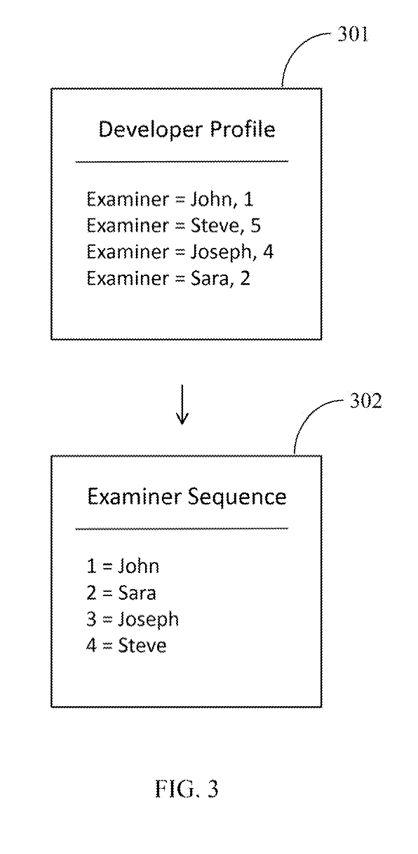

The storage system 110 may allocate space for a profile storage (not shown). The profile storage may store a developer profile for every developer. In FIG. 3, a developer profile 301 is shown according to an embodiment. The developer profile 301 includes an examiner list, in which each examiner is associated with a priority rank. For example, an examiner named “Joseph” is associated with a priority rank “4”. In one embodiment, the lower the number of the priority rank is, the higher the priority is.

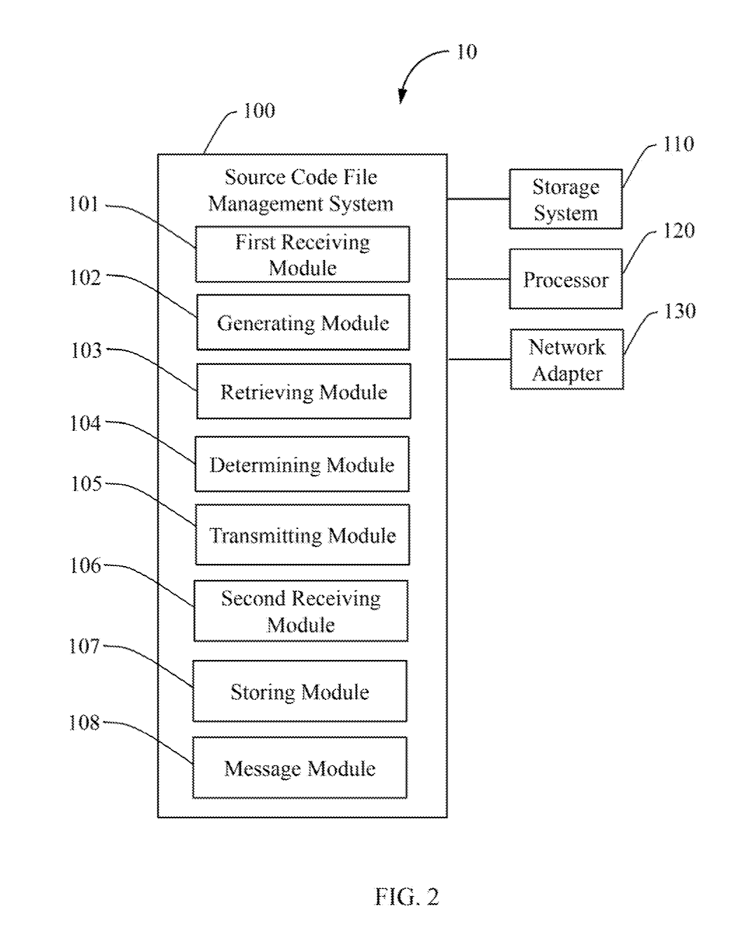

FIG. 2 is a schematic diagram of one embodiment of the function modules of the source code file management system 100. In the embodiment, the source code file management system 100 includes a first receiving module 101, a generating module 102, a retrieving module 103, a determining module 104, a transmitting module 105, a second receiving module 106, a storing module 107 and a message module 108. In some embodiments, each of the modules 101-108 may be a software program including one or more computerized instructions that are stored in the storage system 110 and executed by the processor 120.

The first receiving module 101 may receive a source code file from a developer client 20.

The generating module 102 may generate an intermediate file based on the source code file. The generating module 102 may check whether there is an older version of the source code file in the source code storage. When there is not an older version of the source code file in the source code storage, the generating module 102 can copy the content of the source code file into the intermediate file. When there is an older version of the source code file (older version) in the source code storage, the generating module 102 may further check whether the older version is in all respects the same as the source code file. If the older version is in all respects the same as the source code file, the generating module 102 can instruct the message module 108 to send a rejection message to the developer client 20. The rejection message notifies the developer that the source code file is rejected because there the same file already exists in the source code storage. If the older version is different from the source code file, the generating module 102 can copy the contents of both the source code file and the older version into the intermediate file, and record the difference(s) between the source code file and the older version in the intermediate file.

In one embodiment, the generating module 102 may calculate a check code for both the older version and the source code file. The check code is a cyclic redundancy check (CRC) code or a message digest 5 (MD5) code. In this embodiment, the generating module 102 may check whether the source code file is the same as the older version by comparing the check code of the source code file against the check code of the older version.

The retrieving module 103 may retrieve a developer profile associated with the developer from the profile storage. The determining module 104 may determine a plurality of examiners according to the developer profile. For example, the retrieving module 103 retrieves the developer profile 301 shown in FIG. 3. The determining module 104 can determine four examiners in this embodiment: John, Steve, Joseph, and Sara.

The transmitting module 105 may establish a priority sequence in relation to the plurality of examiners (examiner sequence) according to the priority rank of each of the plurality of examiners and transmit the source code file to the plurality of examiner clients in the examiner sequence. In FIG. 3, an examiner sequence 302 is generated by the transmitting module 105 according to the developer profile 301.

The second receiving module 106 may receive a plurality of examining results from the plurality of examiner clients. When every examining result is accepted, the storing module 107 can store the source code file in the source code storage as requested. When one of the plurality of examining results is rejected, the message module 108 may send a rejection message to the developer client.

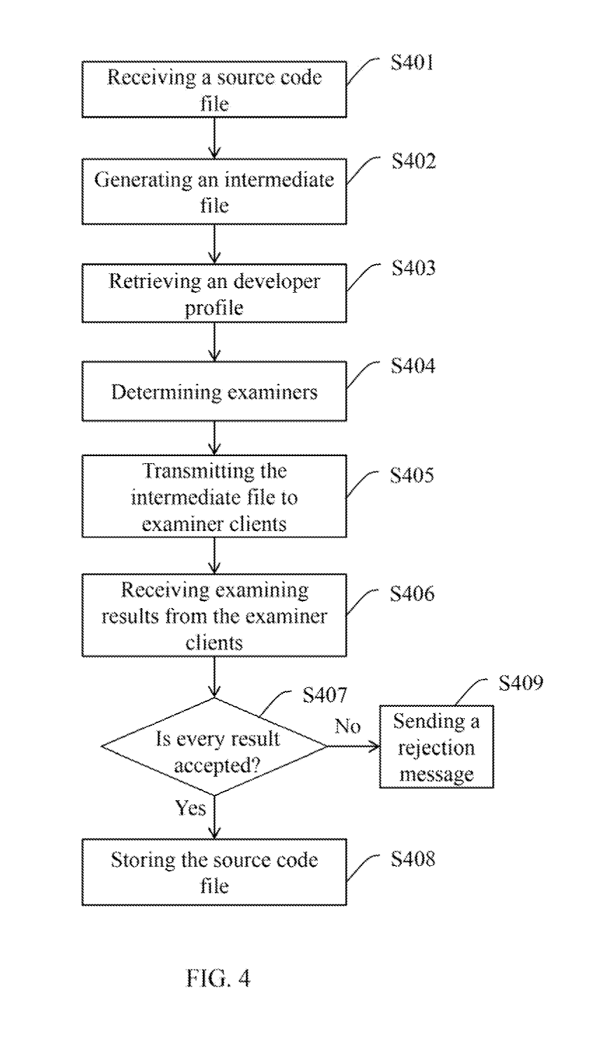

FIG. 4 is a flowchart illustrating one embodiment of a method for examining a source code file before the source code file is committed. The method may include the following steps.

In step S401, the first receiving module 101 receives a source code file from a developer client associated with a developer.

In step S402, the generating module 102 generates an intermediate file based on the source code file.

In step S403, the retrieving module 103 retrieves a developer profile associated with the developer from the profile storage.

In step S404, the determining module 104 determines a plurality of examiners according to the developer profile.

In step S405, the transmitting module 105 establishes an examiner sequence according to the priority rank of each of the plurality of examiners and transmits the source code file to the plurality of examiner clients in the examiner sequence.

In step S406, the second receiving module 106 receives a plurality of examining results from the plurality of examiner clients.

In step S407, if every examining result is accepted, the flow goes to step S408. If one of the plurality of examining results is rejected, the flow goes to step S409.

In step S408, the storing module 107 stores the source code file in the source code storage.

In step S409, the message module 108 sends a rejection message to the developer client.

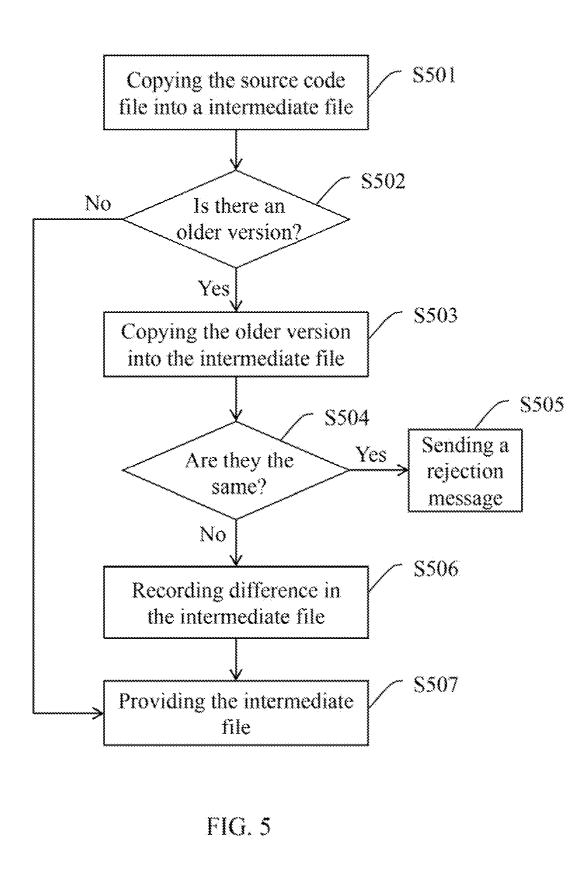

FIG. 5 is a flowchart illustrating one embodiment of a method for generating an intermediate file based on a source code file. The method may include the following steps.

In step S501, the generating module 102 copies the content of the source code file into the intermediate file.

In step S502, the generating module 102 checks whether there is an older version of the source code file in the source code storage. If there is not an older version of the source code file in the source code storage, the flow goes to step S507. If there is an older version of the source code file in the source code storage, the flow goes to step S503.

In step S503, the generating module 102 copies the content of the older version into the intermediate file.

In step S504, the generating module 102 checks whether the older version is the same as the source code file. If the older version is the same as the source code file, the flow goes to step S505. If the older version is different from the source code file, the flow goes to step S506.

In step S505, the generating module 102 instructs the message module 108 to send a rejection message to the developer client.

In step S506, the generating module 102 records the difference(s) between the source code file and the older version in the intermediate file.

In step S507, the generating module 102 provides the intermediate file to the transmitting module 105.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

Depending on the embodiment, certain steps or methods described may be removed, others may be added, and the sequence of steps may be altered. It is also to be understood that the description and the claims drawn for or in relation to a method may include some indication in reference to certain steps. However, any indication used is only to be viewed for identification purposes and not as a suggestion as to an order for the steps.

What is claimed is:

1. A computer-implemented method for managing source code file in a computing device having a storage system, the method comprising:
receiving the source code file from a developer client associated with a developer;
generating an intermediate file based on the source code file;
retrieving a developer profile associated with the developer from a profile storage located within the storage system;
determining one or more examiners according to the developer profile;
transmitting the intermediate file to one or more examiner clients associated with the one or more examiners;
receiving one or more examining results from the one or more examiner clients;
when each of the one or more examining results is accepted, storing the source code file in a source code storage located in the storage system; and
when one of the one or more examining results is rejected, sending a rejection message to the developer client.

2. The method of claim 1, further comprising:
copying content of the source code file into the intermediate file; and
when there is an older version of the source code file in the source code storage, copying content of the older version into to the intermediate file.

3. The method of claim 2, further comprising:
determining whether the source code file is the same as the older version;
when the source code file is the same as the older version, sending the rejection message to the developer client; and
when the source code file is different from the older version, recording the difference between the source code file and the older version in the intermediate file.

4. The method of claim 3, wherein the determining whether the source code file is the same as the older version comprises comparing a source code file check code to an older version of the source code file check code.

5. The method of claim 4, wherein the source code file check code and the older version of the source code file check code are cyclic redundancy check (CRC) code or message digest 5 (MD5) code.

6. The method of claim 1, wherein the storing the source code file in the source code storage comprises:
calculating a source code file check code; and
storing the source code file check code associated with the source code file in the source code storage.

7. The method of claim 1, wherein each of the one or more examiners is associated with a priority rank.

8. The method of claim 7, further comprising establishing an examiner sequence that defines an order of the one or more examiners according to the priority rank, wherein the source code file is transmitted to the one or more examiner clients in the examiner sequence.

9. The method of claim 1, wherein the storing the source code file in the source code storage comprises associating a unique version number with the source code file.

10. The method of claim 1, wherein the computing device is accessible to the developer client and the one or more examiner clients via a network.

11. A computing device comprising:
a storage system;
at least one processor;
one or more programs being stored in the storage system and executable by the at least one processor, the one or more programs comprising:
a first receiving module adapted to receive a source code file from a developer client associated with a developer;
a generating module adapted to generate an intermediate file based on the source code file;
a retrieving module adapted to retrieve a developer profile associated with the developer from a profile storage located within the storage system;
a determining module adapted to determine one or more examiners according to the developer profile;
a transmitting module adapted to transmit the intermediate file to one or more examiner clients associated with the one or more examiners;
a second receiving module adapted to receive one or more examining results from the one or more examiner clients;
a storing module adapted to store the source code file in a source code storage located in the storage system when each of the one or more examining results is accepted; and
a message module adapted to send a rejection message to the developer client when one of the one or more examining results is rejected.

12. The computing device of claim 11, wherein the generating module is further adapted to copy content of the source code file into the intermediate file and when there is an older version of the source code file in the source code storage, copy content of the older version into to the intermediate file.

13. The computing device of claim 12, wherein the generating module is further adapted to determine whether the source code file is the same as the older version, instruct the message module to send the rejection message to the developer client when the source code file is the same as the older version, and record the difference between the source code file and the older version in the intermediate file when the source code file is different from the older version.

14. The computing device of claim 13, wherein the generating module is further adapted to compare a source code file check code to an older version of the source code file check code.

15. The computing device of claim 14, wherein the source code file check code and the older version of the source code file check code are cyclic redundancy check (CRC) code or message digest 5 (MD5) code.

16. The computing device of claim 11, wherein the storing module is further adapted to calculate a source code file check code and store the source code file check code associated with the source code file in the source code storage.

17. The computing device of claim 11, wherein each of the one or more examiners is associated with a priority rank.

18. The computing device of claim 17, wherein the transmitting module is further adapted to establish an examiner sequence according to the priority rank and transmit the source code file to the one or more examiner clients in the examiner sequence.

19. The computing device of claim 11, wherein the storing module is further adapted to associate a unique version number with the source code file.

20. A computer-implemented method for managing source code file in a computing device having a storage system, the method comprising:
providing a first receiving module, a generating module, a retrieving module, a determining module, a transmitting module, a second receiving module, a storing module and a message module;
receiving the source code file from a developer client associated with a developer by the first receiving module;
generating an intermediate file based on the source code file by the generating module;
retrieving a developer profile associated with the developer from a profile storage located within the storage system by the retrieving module;
determining one or more examiners according to the developer profile by the a determining module;
transmitting the intermediate file to one or more examiner clients associated with the one or more examiners by the transmitting module;
receiving one or more examining results from the one or more examiner clients by the second receiving module;
when each of the one or more examining results is accepted, storing the source code file in a source code storage located in the storage system by the storing module; and
when one of the one or more examining results is rejected, sending a rejection message to the developer client by the message module.
